(19) United States
(12) Patent Application Publication
(10) Pub. No.: US 2003/0024988 A1
(43) Pub. Date: Feb. 6, 2003

(54) System for providing evidence of payment

(76) Inventor: David Stanard, Houston, TX (US)

Correspondence Address: Gordon T Arnold, Arnold & Associates, 2401 Fountainview, Suite 630, Houston, TX, 77057, US

(21) Appl. No.: 09/556,333

(22) Filed: Apr. 24, 2000

(51) Int. Cl. G06K 7/10

(52) U.S. Cl. 235/462.01

(57) ABSTRACT

A system for providing evidence of payment wherein each transaction initiated through the system is assigned a unique code. This code, along with other information, such as the customer name or transactional information, is used to generate a two-dimensional barcode which may be sent in an electronic format to the customer. This two dimensional barcode may be stored on in electronic format until such time as the customer needs to show evidence of payment, at which time the customer may print the two dimensional barcode on a printer attached to the computer.

### BACKGROUND OF THE INVENTION

1. Field of the Invention

The present invention relates generally to a system for providing evidence of payment. Specifically, the present invention relates to a computer based system capable of providing event tickets via the Internet, wherein the tickets may be provided directly to the local user.

2. Description of the Prior Art

Presently, tickets for entertainment events must be purchased either in person, in which case the purchaser or customer typically receives a printed ticket immediately, or by phone where the customer must arrange to either pick up the tickets, for instance, at the venue on the day of the event or otherwise have them delivered prior to the event. This can be inconvenient or impossible for certain customers, in which case, the customer may miss an event and the venue will lose a sale.

Recently, use of the Internet to sell goods and services has created additional, more convenient purchasing options for many consumers. Most any item can be found for sale on the Internet, including entertainment event tickets such as concert tickets, movie tickets or tickets to sporting events. One vendor, for example, provides a web site for customers wishing to purchase tickets to a myriad of events around the country. The consumer simply chooses the desired event and supplies a suitable method of payment, such as a credit or debit card number. However, after purchase, the physical tickets must still be picked up by or delivered to the consumer. This does not, therefore, alleviate the problems previously encountered by consumers who do not have the time or ability to pick up or otherwise take receipt of their tickets.

In many cases, it may be equally desirable to pick up the event tickets immediately prior to the event at the venue, however, in certain instances, this may pose significant problems. For instance, where the consumer is unable to attend the event at the last minute, there is no provision to allow the consumer to dispose of the tickets, such as by sale or otherwise offering the tickets to another consumer.

Another problem with relying solely on a “hard copy” or physical, printed ticket is that if the ticket is lost or stolen, there is no way to invalidate or reissue the ticket. Likewise, if a ticket is counterfeited, there is no way to determine, at the point of admittance into a venue, that the ticket is not legitimate.

Therefore, it would be desirable to provide a system that would allow a customer to easily store and/or transfer tickets electronically without the use of a physical, “hard copy” of the ticket being necessary. Additionally, it would be advantageous to allow a customer to print the ticket himself on a printer attached to a personal computer, for instance, thereby eliminating the need to actually pick up the tickets or have them delivered.

### SUMMARY OF THE INVENTION

The present invention provides a system and method for providing secure and encrypted evidence of payment. Specifically, the system of the present invention provides an interface between a customer and at least one database to provide event tickets that may be printed or otherwise delivered to a user through or via a personal computer, preferably by using the Internet or other computer network.

The system allows a customer or potential customer to access and review any number of databases which contain venue information for at least one entertainment venue. These databases may contain information relating, for instance, to the number and price of seats in the venue, the dates and times of specific events, and any other information relating generally to the venue or to a specific event. The database may also provide information relating to the current availability of seats. The system may include a plurality of databases corresponding to any number of venues in any number of locations. In this way, a customer may access venue information for local as well as non-local entertainment events. The customer may register on the system, at which time he will typically be assigned a username and password to allow him to log into the system. It should be understood, however, that registration is not necessary and a customer may be allowed restricted, partial or complete access to the system either with or without completing the registration process. The customer may then select a venue, a specific event and a seat or number of seats. The system will verify availability of the seats chosen by the user or customer and place a temporary hold on the seats to prevent duplicate sale of the seats prior to resolution of the customers transaction. The customer may then provide the system with payment information, typically in the form of credit card information sufficient to allow the system to charge the customer's credit card account. Alternatively, the system may employ any suitable method of payment, including allowing the use of debit cards, electronic checks or direct checking account withdrawals, for instance, thereby allowing users to set up and fund an account within the system either for their own personal use or in the form of a “gift certificate” wherein the specific account information may be given or passed to another individual to allow that individual to purchase tickets through the system without requiring the use of the individual personal credit card or funds. Once the system has verified the credit card information and charged the customer's account, the system will then designate or mark the particular seats as “sold” or otherwise unavailable for future purchase.

Upon completion of the purchase transaction, the system will generate a specific, unique encrypted code or signature which corresponds to each venue, event and seat ticket the customer purchased. The digital signature created by the system in unique to both the specific venue, event and seat, as well as to the customer. Therefore, the digital signature essentially binds the specific seat to the customer. This signature may then be used as part of the data contained in a two-dimensional barcode. The two-dimensional barcode may contain additional information related to the specific venue, event, seat locations, as well as related to specific customer information, such as the customers name and other information which may be used to identify the individual when the ticket is presented to gain entrance to the event. The user may print the ticket from his PC using any suitable printer. The ticket will typically contain, in addition to the encrypted two-dimensional barcode, certain user readable information. Such information may include, for instance, the date, time and location of the event as well as the specific seats which are represented by the ticket. A scanning station at the event reads the information from the encrypted barcode and transmits that information to a processor which interfaces with the system database to verify that the ticket has not been previously used, invalidated, forged or otherwise tampered with. This processor may be located at the venue or at some other location, depending on the specific requirements of the system and the infrastructure and bandwidth available at the venue.

The barcode generated by the system is a two dimensional barcode and is typically encrypted. In this way, the barcode may be transmitted over a computer network, such as the Internet, and may be printed directly on a printer attached to the customers personal computer (“PC”). The ticket need not be printed immediately at the time of purchase, but may be stored electronically, either on the customers PC or in the system. In either case, the ticket may then be printed at a later time, thereby decreasing the chance of ticket loss prior to the event. In addition to storing information regarding the specific event and customer, the two-dimensional barcode may also contain information that will allow verification of customer identity when the ticket is presented at a venue. For instance, a personal identification number (“PIN”) may be encoded into the barcode, which may be later verified by the customer at the venue when the ticket is presented.

Another aspect of the present invention is the ability to transfer a ticket without the need to exchange a physical embodiment of the ticket. Typically, a user who is unable to use a ticket or otherwise desires to transfer ownership of the ticket to another, will enter the system and provide certain specific information about the transferee to allow the system to create and issue a separate unique digital signature and create a second two-dimensional barcode which is specific to the transferee. The system will also cancel the previously issued code, thereby effectively invalidating the first ticket.

The system of the present invention may be used in situation where a secure method of evidence of payment is required. For example, the same information contained in the ticket may be appended to an electronic mail or other message as part of a wireless area protocol (“WAP”) message to a cellularl telephone or other wireless device, such as a personal digital assistant (“PDA”). An interface between the phone or PDA and the ticket booth or scanning station at the venue would then allow passage into the venue by the user of the wireless device.

### BRIEF DESCRIPTION OF THE DRAWINGS

FIG. 1 shows a schematic of a system of the present invention.

FIG. 2 shows a schematic of a customer database.

FIG. 3 shows a schematic of a ticket database.

FIG. 4 shows a schematic of a venue component of FIG. 1.

FIG. 5 shows a venue database and scanning station.

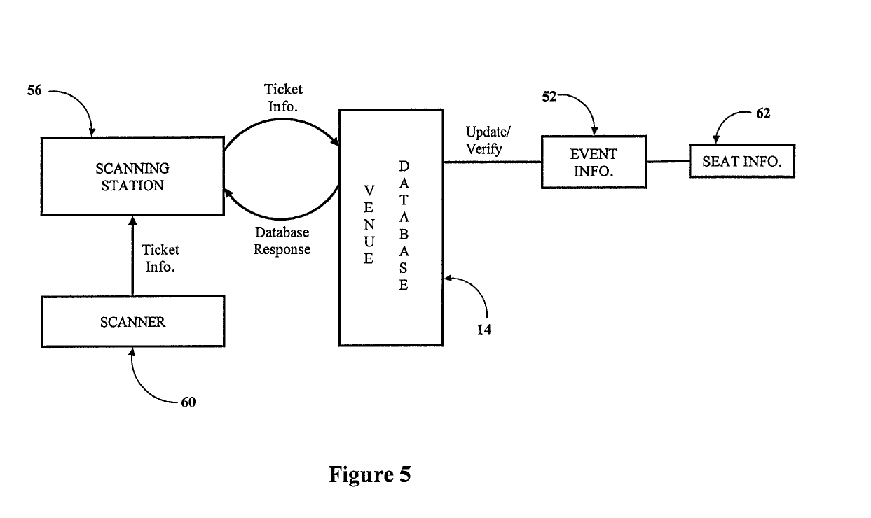

### DETAILED DESCRIPTION OF THE PREFERRED EMBODIMENTS

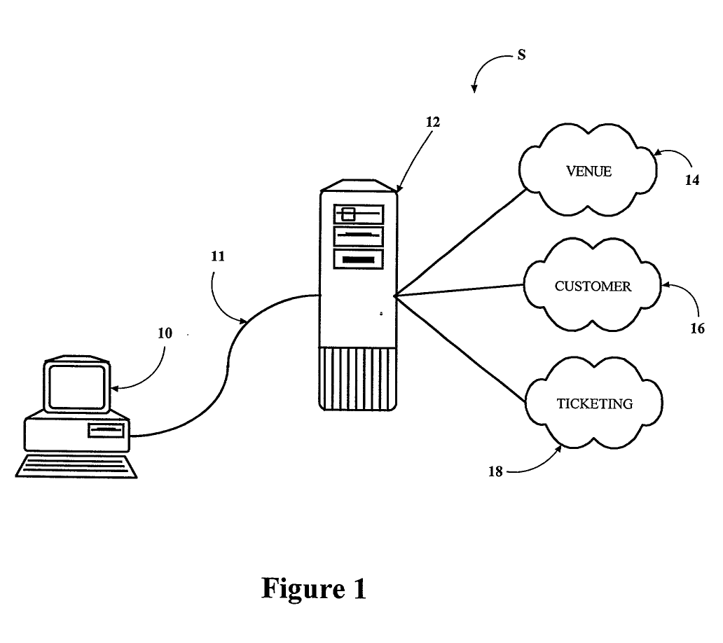

As shown in FIG. 1, the systems of the present invention provides at least one central server 12 which may be connected to a computer network” such as the Internet. The server 12 preferably contains at least one venue component 14, or database 14, at least one customer component or database 16 and a ticketing component or database 18. In a preferred embodiment, the system includes a plurality of venue components corresponding to a plurality of venues. The system may be accessed by a remote customer having a personal computer 10 with the capability to access the computer network 11.

A user may access the systems through the Internet or world wide web, using any suitable web browser or other software. Upon initially entering the system, the user will preferably be presented with a plurality of options to determine the specific need or requirement of the user. For instance, the system may allow an existing user to enter a username and password, thereby identifying the user to the system and allowing further access thereto. Alternatively, the system may allow a new user to set up an account within the system.

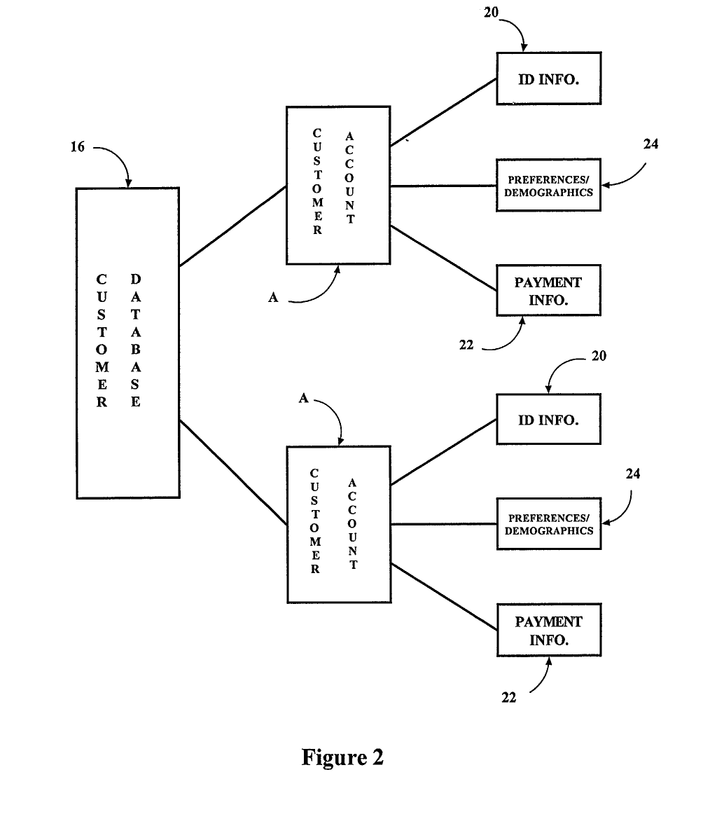

As shown in FIG. 2, the systems of the present invention may include a customer or user database 16. When a new user desires to set-up or create an account A on the systems, the system may prompt the user for a variety of information. Such an information may include, for instance, the user's name, street or home address, email address 20 and any other information necessary to process subsequent purchases 22, such as the user's credit card number, checking account number or other information which would allow for a suitable method of payment. In addition, the system may also request certain demographic information, such as the user's age, income level, family status or personal interests or hobbies 2A. The information obtained from the user by the system is then stored in the customer database 16 for subsequent access and use by the systems. The systems will typically include a mechanism or process whereby the user may change certain information stored in the customer database, such as the users address or payment information.

A user will preferably log into the system. The log-in process typically includes inputting certain identifying information, such as a username and password, so that the system can access the users individual account information in the customer database and verify the identity of the user. Once the users identity has been verified and the user is logged into the system, the user is presented with a number of additional selections or options to obtain further information or to purchase tickets. In the event that a user loses, forgets or misplaces his login information, the system may provide a mechanism to allow the user to obtain the password, such as by requiring the user to supply additional identifying information to the system or by emailing the password to the users prespecified email account. Depending on the specific requirements of the system, registered users may be allowed greater access to advanced system feature, for example, to which non-registered users may not have access. Preferably, however, it will not be necessary to register with the system to purchase tickets or obtain general information through the system.

Once the user has logged into the system, the user is presented with a variety of options. Such options may include viewing information relating to a specific venue, purchasing tickets, obtaining a refund on a previously purchased ticket, transferring a ticket to another user, or reissuing a lost, stolen or destroyed ticket. It should be understood, however, that any number of options may be presented to the user, depending on the specific requirements of the system and the user.

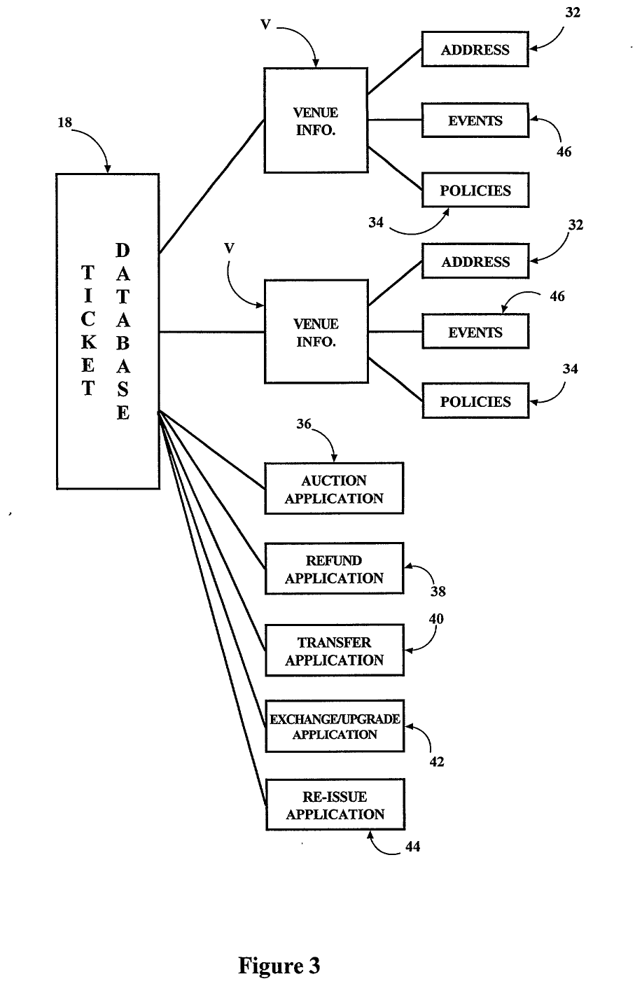

FIG. 3 shows a ticket component or database 18 of the present invention. The ticket database stores all information regarding each of the venues which are part of the systems in separte venue accounts. Such information 30 may include, for instance, general mailing information 32, venue ticketing policies 34, venue events 46, etc. The ticket database communicates with both the customer database 16 and the venue database 14 to provide all the information necessary to effectively distribute and manage the tickets issued through the systems.

The ticket database 18 may include any number of modules, components or applications, depending on the specific application requirements. Preferably and depending on the requirements of each specific venue included in the system, the ticket database may provide or include applications for auctioning tickets 36, refunding tickets 38, transferring tickets 40, exchanging or upgrading tickets 42 and re-issuing tickets 44. Any combination of these applications may be included for each individual venue, as well as any other number of applications as required by the venue.

The primary function of the ticket database is to generate and manage a unique, individual digital code or signature that represents each individual seat at each individual event at each individual venue. When a customer chooses a seat or seats for a particular event and after the seats are located in the venue database and verified as available. The ticket database will place a temporary hold on the seats while the customers transaction is being completed (ie. the customers payment information is unified). The ticket database then generates a digital signature which represents the specific seat or seats for the particular event and venue. In addition, the signature associates or binds the specific seat to the customer or purchaser. This signature may be any suitable alphanumeric descriptor. Once a code is assigned to a particular seat, all future transactions regarding the particular seat will be accomplished using the assigned signature. Preferably, the digital signature is encrypted using any suitable encryption methodology or algorithm.

The digital signature is not only used to track the ticket within the system, but it is also used included as part of the two dimensional barcode. U.S. Pat. No. 4,939,354 (Figarella) describes a suitable method for generating two dimensional barcodes, however, any suitable method may be used in the present invention. This barcode may contain not only the digital signature which identifies the specific venue, event and seat represented by the ticket, but may also contain information regarding the customer. For instance, certain identification information may be contained within the barcode to allow verification of identification when the ticket is presented. In this way, not only does the ticket represent a particular seat, it also binds that particular seat to a specific customer. This key feature of the present invention differentiates the present system from the prior art. Hence, where a ticket is stolen or counterfeited, for instance, the identity of the person presenting the ticket at the venue may be verified to determine if, in fact, they are the authorized purchaser or owner of the ticket. Similarly, once the system has been notified that a particular ticket has been lost or stolen, for instance, the system can invalidate that particular ticket, thereby preventing future use. The use of a barcode to represent the digital signature, among other things, further increases the security of the system. Although the digital signature is typically encoded, the bar code further deters decoding of the data contained therein, due to its machine readable nature.

By using a digital signature to represent each ticket, the system is capable of providing a variety of features which are not possible in prior art systems. For instance, the present system may allow a customer to transfer a ticket to another customer without the need for physically exchanging the ticket. Since the ticket is bound not only to a specific seat, event and venue, but also to a particular customer, all that is necessary to effect a transfer is to identify within the system that the ticket no longer belongs to the first customer, but now to the second customer. Preferably, this is accomplished by invalidating the first digital signature and generating a new digital signature representing the specific seat, event, venue and the new ticket owner.

The use of a digital signature also allows a customer to request that a ticket be re-issued, in the case where the original was lost or stolen. In such cases, the system simply invalidates the first digital signature and creates a new digital signature which represents the “new” ticket. All of the data regarding the particular seat, event, venue and customer may remain the same, but the issuance of a new signature prevents use of the old, lost or stolen ticket and allows the customer to simply print a new ticket.

Once a digital signature is generated it may be sent to the customer over a computer network, such as the Internet. The user may choose to simply store the signature on his personal computer or he may print the ticket immediately. In either case, any number of physical, printed tickets may be generated, however, only one may be used to gain admittance or entrance to particular event. This capability allows the customer great flexibility in keeping track of his tickets. As ticketing for various events begins to occur further and further in advance of the actual event, the chance that a customer may misplace or lose his tickets increases. The present system greatly reduces or eliminates the possibility that a customer will permanently lose his tickets.

The two dimensional bar code created by the system from the digital signature is similarly unique to both the particular seats and to the purchaser. The bar code from which the ticket is formed may be provided to the purchaser by any suitable method. Preferably, the bar code and associated ticket information is provided electronically via the Internet or other computer network. Once the customer receives the electronic information, he may immediately print a ticket using any suitable printer, for instance a printer attached to the customers PC. The electronic information may also be stored on the customers PC and the ticket printed at some future time.

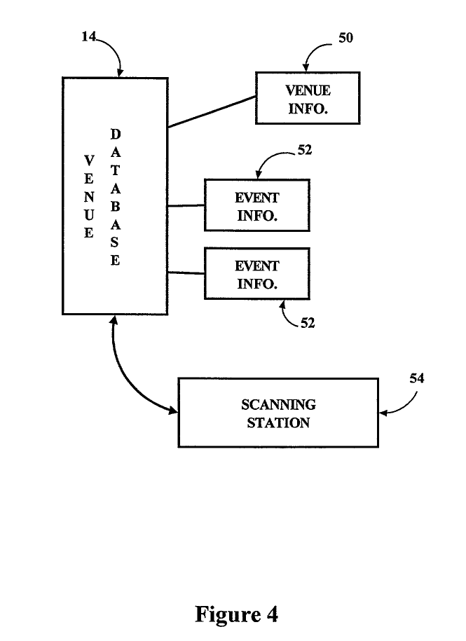

As shown in FIG. 4, the venue component or database 14 includes at least one database 50 containing information relating to the specific venue. The venue may be any location or facility capable of selling seats, space or otherwise allowing a user or customer to gain entrance or admittance. For instance, professional sports arenas, college athletic facilities, movie theaters, concert halls and the like. The venue database 14 may contain event information relating to the seating arrangement at the particular event, such as the number of seats, their location relative to the stage, playing field, etc., the cost of each seat and availability of such seats. Event information may be contained in an event database 52. The venue database 14 also allows the systems to track or designate which tickets have been purchased or reserved and which are still outstanding and available, thereby preventing the sale or disbursement of a single seat to multiple customers. The venue database 14 is also responsible for maintaining a list of those tickets which have been used to access the event. Any suitable method for inputting specific ticket data capable of informing the system that a particular ticket has been used is acceptable. Preferably, a plurality of scanning stations 56 are used at the entry points to the venue to scan the two-dimensional barcode on the ticket.

The venue database 14 may be physically located on-site at the particular venue or may be located remotely, for instance at a centralized location. Where the venue is capable of providing the required infrastructure, such as cabling, high speed network connections and the like, the venue database 14 may preferably be located in a remote, centralized location. In this way, the systems may be continuously monitored by technicians capable preventing potential problems or quickly repairing system components that are inoperable. It should be understood, however, that the physical location of the venue database is discretionary.

As shown in FIGS. 4 & 5, a scanning station 56 is connected to and interfaces directly with the venue database 14, either via wired or wireless connection 58. As customers present their tickets at the venue, a suitable scanner is used to scan the two dimensional barcode on the customers ticket. The scanning station 56 may then send the encrypted or encoded data from the ticket directly to the venue database 14, via the systems, where it is decoded, analyzed and verified. Alternatively, the scanning station 56 may contain hardware or software capable of decoding or decrypting the two dimensional barcode and may then send the decoded ticket data to the venue database. In either case, after the ticket information is verified, the systems updates the venue database 14, specifically, seating information 62 in the event database 52 is updated to reflect that the ticket has been used.. The venue database 14 will typically send one of three responses to the scanning station 56 after ticket information has been sent. The venue database 14 may send an “accept” response, which will allow the user to enter the venue, a “reject” response, which requires the customer to speak with a customer service representative or other employee of the venue, or a “verify” response, which means further verification of the customers identity is required. This further verification may include, for instance, requiring the customer to show an identification card, such as a drivers license or may simply require the user to enter a preassigned personal identification number. The digital signature, and thus, the two-dimensional barcode contains various identifying information related to the purchaser of the tickets. In this way, the system can provide specific identifying details about the given user and therefore allow verification of the customers identity. The scanning stations may require venue employees to operate or may be completely automated.

In addition to its use in providing an improved method of ticketing, the present system may be adapted to provide evidence of payment in any number of additional businesses or industries. The method by which an individualized and unique digital signature is assigned to a ticket, as previously described, may be applied to virtually any type of goods or services. As more and more portable wireless computers are introduced (i.e., celluar telephones, PDA's, Smartchip cards, etc.), they may be used as alternate carriers of the information contained in the two dimensional bar code. The system still creates a secure evidence of payment which holds certain information relating to the customer and the venue. Interfaces at the venue between a scanning station, for instance, and the wireless device would allow a customer to buy and store a true electronic ticket to a venue event.

The foregoing disclosure and description of the invention are illustrative and explanatory thereof, and various changes in the size, shape and materials, and components, as well as in the details of the illustrated construction may be made without departing from the spirit of the invention.

We claim:

1. A system for providing evidence of payment comprising:
(a) a central system for managing at least one database, said database containing information related to available goods or services, wherein said system assigns a unique signature which associates a good or service purchased from said database with a specific purchaser;
(b) a system for creating a two dimensional barcode containing said unique signature.

2. A method for providing tickets for entertainment events comprising:
(a) a customer database containing information relating to customers of the system;
(b) a venue database containing information relating to venues serviced by the system, wherein said information includes the number of seats available at the venue;
(c) a ticketing system capable of accessing the customer database and venue database to uniquely associate an individual customer with an individual seat at an individual venue.

3. The method of claim 2, wherein said ticketing system associates said customer with said seat by creating a digital signature containing information which identifies both the seat the and customer.

4. The method of claim 3, wherein said ticketing system is further capable of generating a two dimensional barcode from said digital signature.

5. A system for providing tickets comprising:
(a) a server containing at least a customer database containing information relating to customers of the system; a venue database contain information relating to the particular seats contained in the venue and a ticketing system, wherein said ticketing system is capable of accessing said customer database and said venue database and associating a particular customer in the customer database with a particular seat in the venue database.

6. The system of claim 5, wherein the particular customer is associated with a particular seat by creating a single, unique digital signature which contains identifying information for the customer and the seat.

7. The system of claim 6, wherein said ticketing system creates a two dimensional bar code from said digital signature.
